(19) United States
(12) Patent Application Publication
(10) Pub. No.: US 2003/0090103 A1
(43) Pub. Date: May 15, 2003

(54) Direct mailing device

(76) Inventor: Thomas Becker, Willow Springs, IL (US)

Correspondence Address: SONNENSCHEIN NATH & ROSENTHAL, Wacker Drive Station, Sears Tower, P.O. Box 061080, Chicago, IL, 60606-1080, US

(21) Appl. No.: 10/039,566

(22) Filed: Nov. 9, 2001

(51) Int. Cl. G09F 1/00

(52) U.S. Cl. 283/56

(57) ABSTRACT

This invention relates to an advertisement device for direct mailing to a recipient, and in particular to an advertisement device for direct mail delivery to a recipient. The advertisement device has a synthetic panel with a back side and a front side, at least one of the back side and the front side adapted to receive delivery information, and a thickness sufficient to maintain integrity of the synthetic panel. A method of delivering an advertisement device to a recipient having a synthetic panel, having a back side, a front side adapted to receive delivery information, and a thickness sufficient to maintain integrity of the synthetic panel is also provided. Also provided is an advertisement device system for direct mail delivery to a recipient, having a synthetic panel, with a back side, a front side adapted to receive delivery information, and a thickness sufficient to maintain integrity of the synthetic panel; and means for applying delivery information. The device may also include an anti-microbial agent to at least partially inhibit the growth or accumulation of undesirable biological agents thereon.

### FIELD OF THE INVENTION

This invention relates to advertising and, more particularly, to an advertisement device for direct mail delivery to a recipient.

### BACKGROUND OF THE INVENTION

Marketers for centuries have attempted to grasp the attention of potential consumers by using whatever technology, service or infrastructure available. Most of these techniques, however, fail to provide any long-term impact on the purchasing decisions of the consumer. One method used to attract customers is to utilize the surface of retail display surfaces or display mediums, such as counter tops, or the interior or exterior surfaces of a wall or window of a store, a door, a building, or a vehicle, etc. However, this approach generally cannot impact purchasing decisions made at home, the work place, or any other location other than the retail location where advertisement is displayed.

Another method used to attract customers is mass mailing of printed material such as brochures, catalogs, postcards, advertisements enclosed in envelopes, and the like. However, these forms of advertisement are expensive to produce, handle, and/or deliver when compared to the results they obtain. Moreover, advertisements mailed in envelopes require not only the expense of complex machinery or labor to stuff the envelopes, but postage costs can also be expensive. Mailing brochures have similar problems in that they are expensive to produce and require machinery or people to fold and secure the brochures before they are mailed. Catalogs are also expensive to produce and mail.

While postcards avoid the problems associated with envelope mailing and brochures, they have limitations. For instance, postcards are made of paper generally to facilitate writing correspondence and address information on the postcard with a pen or pencil. As a result, postcards have several disadvantages. First, there are a limited number of printing techniques available for use with paper. Second, oil, dirt and water can stain a postcard. Third, the integrity of a postcard deteriorates with handling and time. For instance, postcards may be damaged in mailing or may become dog-eared with time and physical handling. These types of advertisements also commonly lack the dramatic impact required to grasp and hold the attention of consumers necessary to influence their purchasing decisions.

Another approach to attract customers is conventional print advertising. Conventional print advertising is accomplished by printing stationary non-moveable information and pictures on magazines, newspapers, brochures, flyers, posters, billboards, signs, wrapper, boxes, etc. Many conventional print advertisements and packages do not attract the attention of customers, and are ill suited for mass mailing.

Conventional print advertising materials or devices delivered to a recipient via a delivery service may also be susceptible to accumulating or carrying biological agents, such as microbes, bacteria, fungi, yeast, molds, and the like during shipping and handling in the delivery process. Such biological agents typically develop and grow fast, and can be harmful to the recipient (depending upon the type of biological agents that accumulate on the particular advertising material or device) because they may potentially inflict disease or other biological harm upon the recipient. It would, therefore, be desirable to provide print advertising materials or a mailing device and method for making the same that at least partially inhibits biological agents from forming, accumulating or developing thereon.

It is, therefore, desirable to provide an improved advertisement device that overcomes most, if not all, of the preceding problems, and which takes advantage of the availability of direct mail delivery services for mailing advertisements to consumers, and which may further take advantage of the availability of display surfaces controlled by and frequently seen by the consumer, such as countertops, walls, windows of buildings, vehicles and the like, for advertising products and/or services.

### SUMMARY OF THE INVENTION

This invention relates to an advertisement device for direct mail delivery to a recipient The advertising device has a synthetic panel, having a back side, a front side, at least one of the back side and the front side adapted to receive delivery information, and a thickness sufficient to maintain integrity of the synthetic panel. The present invention also relates to a method of delivering an advertisement device to a recipient having a synthetic panel, having a back side, a front side, at least one of the back side and the front side adapted to receive delivery information and a thickness sufficient to maintain integrity of the synthetic panel. This invention also relates to an advertisement device system for direct mail delivery to a recipient, comprising a synthetic panel, having a back side, a front side, at least one of the back side and the front side adapted to receive delivery information, and a thickness sufficient to maintain integrity of the synthetic panel, and means for applying delivery information.

### BRIEF DESCRIPTION OF THE DRAWINGS

The components in the figures are not necessarily to scale, emphasis instead being placed upon illustrating the principals of the invention. Moreover, in the figures, like reference numerals designate corresponding parts throughout the different views.

FIG. 1 is a front view of one example of the advertisement device;

FIG. 2a is a cross-sectional view of the advertisement device of FIG. 1;

FIG. 2b is a cross-sectional view of the advertisement device of FIG. 1, with a means to detachably attach the advertisement device to a surface;

FIG. 3 is a front view of another example of the advertisement device, which has frangible edges and a cutout;

FIG. 4a is a cross-sectional view of the advertisement device of FIG. 3;

FIG. 4b is a cross-sectional view of the advertisement device of FIG. 3, with a means to detachably attach the advertisement device to a surface;

FIG. 5 is a schematic view of an example of a method of delivering to a recipient an advertisement device by direct mail delivery;

FIG. 6 is a schematic view of an example of an advertisement device system for direct mail delivery to a recipient;

FIG. 7 is a front view of an alternate embodiment of the advertisement device with a mechanism to hold the device with respect to a surface; and

FIG. 8 is a front view of an alternate embodiment of the advertisement device with a mechanism to carry another item therewith to a recipient.

### DETAILED DESCRIPTION OF THE INVENTION

While the present invention may be embodied in many different forms, several specific embodiments are discussed herein with the understanding that the present disclosure is to be considered only as an exemplification of the principles of the invention, and it is not intended to limit the invention to the embodiments illustrated. Where the invention is illustrated herein with particular reference to front and back, or top and bottom, or left and right, it is understood that any other orientation along any axis of the advertisement device can, if desired, be substituted for the embodiments as herein described.

The present invention is generally directed to an advertisement device for direct mail delivery to a recipient. The advertising device comprises a synthetic panel, having a back side, a front side, at least one of the back side and the front side adapted to receive delivery information, and a thickness sufficient to maintain integrity of the synthetic panel. A method of delivering an advertisement device to a recipient is also provided. The method comprises printing an advertisement related to a product and/or a service on a synthetic panel having a back side, a front side, at least one of the front side and the back side adapted to receive delivery information, and a thickness sufficient to maintain integrity of the synthetic panel; applying the delivery information to the synthetic panel; and delivering the advertisement device to a recipient by a direct delivery mail service. An advertisement device system for direct mail delivery to a recipient is also provided. The advertisement device system comprises a synthetic panel, having a back side, a front side, at lease one of the back side and the front side adapted to receive delivery information, and a thickness sufficient to maintain integrity of the synthetic panel; and a means for applying delivery information. The synthetic panel may take a shape related to a theme of the product or the service being advertised. Further, this shape may be formed using a partially perforated cutout embedded in the synthetic panel.

The synthetic panel (101, 201) is a panel made of material produced by synthesis, and not of natural origin, such as from synthetic chemical compounds or material. Such material includes, but is not limited to, vinyl, styrene, polyester, polyvinyl chloride, plastic, fabric, nylon, Nomex™, Kevlar™, polyethylene terephthalate, polycarbonate, acrylic, Plexiglas™, polypropylene, polyethylene, polystyrene, acrylonitrile-butadiene-styrene terpolymer, polyphenyleneoxidepolystyrene, polyurathane, and polyamides, and blends and combinations thereof.

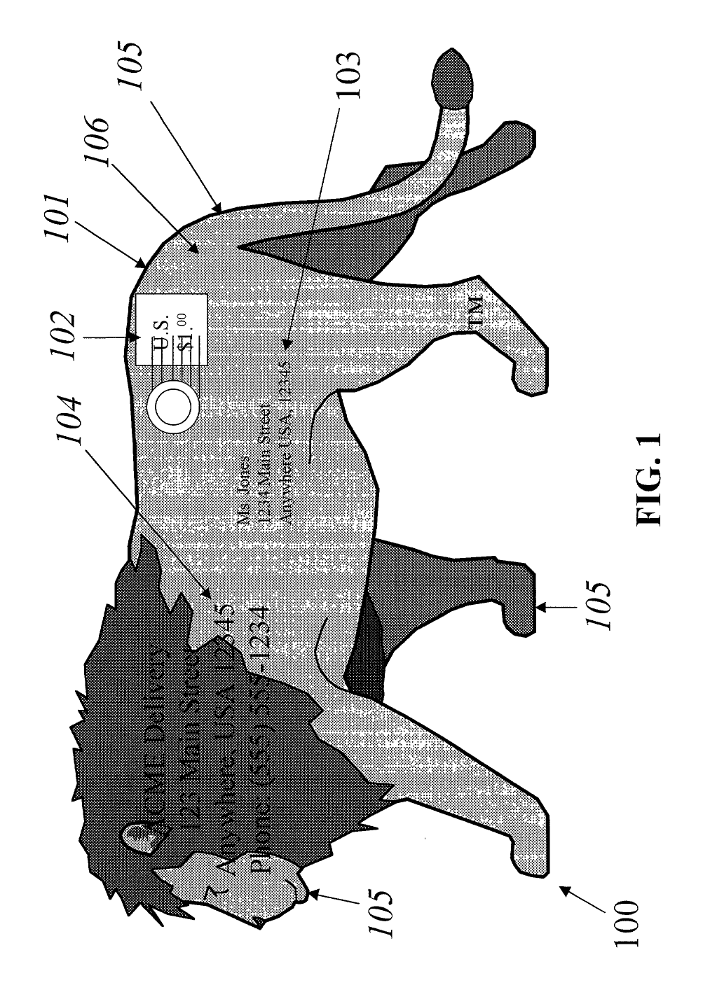

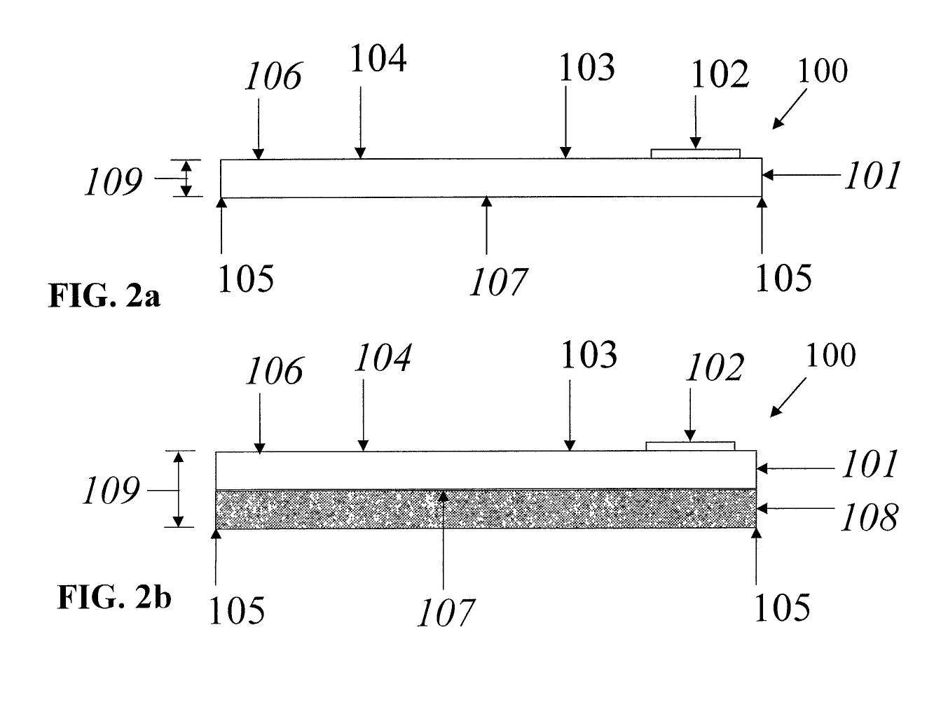

Referring to FIG. 1, the front side of an advertising device (100) is shown having a synthetic panel (101), with a front surface (106); a theme related to Acme delivery service (a fictitious delivery company); a printed pattern and a shape resembling a lion, which represents the fictitious trademark and service theme of Acme Delivery; contact information (104) for Acme Delivery printed on the front surface of the synthetic panel (101); an edge (105), delivery information (103) printed on the front surface (or the back surface in alternate embodiments) of the synthetic panel (101); and postage (102) for direct mail delivery. Referring to FIG. 2a, the advertising device (100) of FIG. 1 is shown in cross section, having a back surface (107), and a thickness (109) sufficient to maintain integrity of the synthetic panel (101). Referring to FIG. 2b, a second example of the type of advertising device depicted in FIG. 1 is shown in cross section. As this cross-section shows, this example has (in addition to many of the attributes) means for detachably or permanently fastening (108) the advertising device to a display surface, and a thickness (109) sufficient to maintain integrity of the synthetic panel (101).

Synthetic panel (101, 201) has several advantages that make it better for use in direct mail advertising. For instance, the synthetic panel is resistant to soiling from dirt, oil, water, and the like; maintains its integrity during: (a) the printing and die cut or molding processes, (b) handling by a direct mail delivery service, (c) handling by a recipient, and (d) its continued display.

The synthetic panel is preferably of sufficient thickness to maintain integrity of the synthetic panel during direct mail delivery to a recipient and, thus, through its continued use and display by the recipient. In one embodiment, the synthetic panel has a thickness of between about 0.001 mm to about 10.0 mm. However, it is contemplated that synthetic panel of the advertisement device could be between about 0.05 mm to about 2.0 mm in thickness or even between about 0.175 mm to about 0.75 mm in thickness, the thickness being essentially a design choice. The synthetic panel (101, 201) can be flexible or inflexible. The synthetic panel may be opaque, transparent or translucent. In fact, the synthetic panel (101, 201) can include paper, covered, layered, laminated, coated or embedded with a synthetic material in such a manner as to achieve some or all of the benefits provided by the synthetic materials.

The synthetic panel member of the advertisement device (100, 200) will generally be printed with alphanumeric and graphic information. The use of a synthetic panel makes it necessary to utilize specialized printing materials and techniques, such as silk screening printing processes, sheet fed or web offset printing, web letter press printing, gravure printing, or printing utilizing ink jet printing technology. The printing inks are generally formulated for printing on the synthetic materials (as opposed to paper-type substrates) for enhanced adhesion and practical durability. Examples of the synthetic formulated printing inks include those manufactured and sold commercially by the companies Toyo Ink America LLC (with an office at 910 Sylvan Avenue, Englewood Cliffs, N.J. 07632 201-568-8660), Kohl & Madden (with an office at 222 Bridge Plaza South, Ft. Lee, N.J. 07024 201-886-1203), Handschy Industries (with an office at 13601 S. Ashland Avenue, Riverdale, Ill. 60628 708-597-7990) and Inx International Ink Company (with an office at 651 Bonnie Ln., Elk Grove Village, Ill. 60007 847-981-9399). A portion or the entire front and/or back surface of the synthetic panel of the advertising device can be printed, herein termed the “print patter.” The print pattern is typically a pattern of dots, lines or other plurality of discrete elements and/or a grid pattern surrounding a plurality of unprinted areas. A synthetic panel can contain names, words (for example, delivery or contact information), symbols, phrases, terms, advertising, such as a multicolor logo, or a design, such as a picture, emblem or logo, and/or other pictures or scenes, etc., including for example, trade names, trademarks, and/or service marks. One or both sides of the synthetic panel can receive printing or coating with appropriate materials. Delivery or contact information generally contains the name (or “current resident”) and address of the recipient and postage where, for example, the United Stated Postal Service is used.

The synthetic panel may also have at least one printed pattern printed thereon related to a theme of a product and/or a service; and/or a shape related to a theme of a product and/or a service; and/or a cutout embedded in the synthetic panel related to a theme of a product and/or a service. The cutout may be a geometric (e.g. square, trapezoidal, oval, elliptical, circular, triangular, rectangular, polygonal) or a contoured shape. Contoured shapes can resemble, for example, the shape of any object, person, place or thing such as historical figures, celebrities, animals, electronic or mechanical devices; vehicles, appliances; toys; personal items; an item of commerce (e.g. credit cards, or trademarks, and food items). The shape of a synthetic panel or cutout, however, is not critical. And a synthetic panel or cutout can be shaped in many forms too numerous to be listed herein, but are nonetheless contemplated to be included within the scope of the present invention.

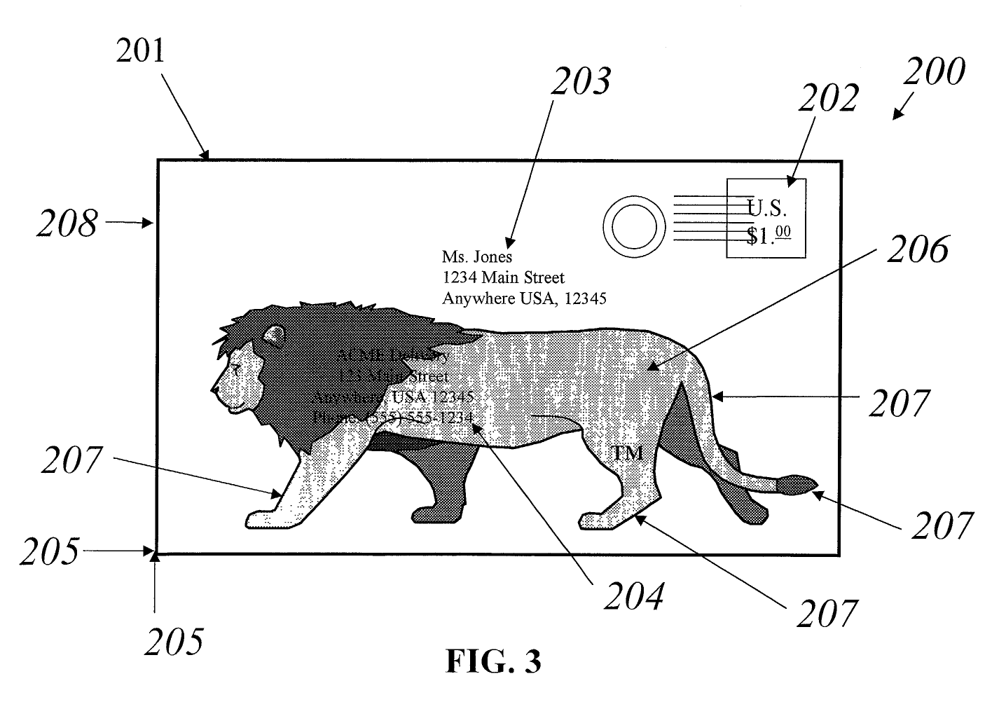

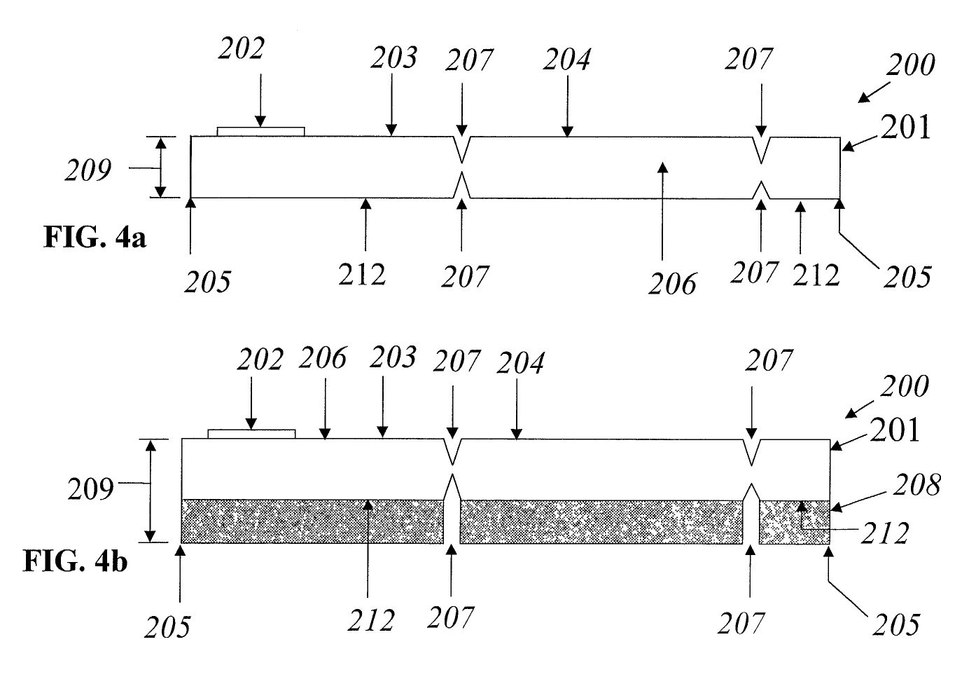

In one approach, the shape may be solely pre-configured to facilitate formation. Referring to FIG. 3, the front side of an advertising device is shown having a synthetic panel (201), having a cutout (207) with a frangible edge delineated by a score or a cut, an edge (205); delivery information (203) printed on one of the front surface (207) or the back surface (hidden from view in FIG. 3) of the synthetic panel (201); postage (202) for direct mail delivery; and a cutout (207) having a theme related to Acme delivery service, and contact information (204) for Acme Delivery printed on the surface of the cutout (207). Referring to FIG. 4a, the advertising device of FIG. 3 is shown in cross section, having a back surface (212); a thickness (209) sufficient to maintain integrity of the synthetic panel during direct mail delivery to the recipient; and a cutout (207) having an area on the front surface (206) of the cutout (207) adapted to receive contact information for Acme Delivery, and a back surface (212). FIG. 4b shows the types of the advertising device with means for detachably fastening (208) the advertising device to a display surface applied on the back surface of the frangible edge and the cutout (207).

In one embodiment, an anti-microbial agent is added to the synthetic material of the synthetic panel or mailing device to help at least partially inhibit the growth, development or accumulation of undesirable biological agents thereon. Such undesirable biological agents may include, for example, microbes of bacteria, yeast, fungi, mold, and the like To inhibit their growth, development or accumulation, an anti-microbial agent, such as a predetermined chemical or compound that can serve such purpose, is incorporated into the synthetic material of the synthetic panel or mailing device when the synthetic material is manufactured or prepared, such as when it is extruded into sheets for example. Various types of anti-microbial agents are available commercially for such purpose, such as those sold by Microban Products Company, which has an office at 11515 Vanstory Drive, Huntersville (N.C.) 28078 (704-875-0806) and AgION Technologies L.L.C., which has an office at 60 Audubon Road, Wakefield, Mass. 01880 (781-224-7100). Some of these anti-microbial agents, or chemicals, can be added to most types of molecular plastics, synthetic fibers, and the like. The anti-microbial agents are added to the synthetic material typically in a predetermined ratio or amount when the synthetic material is manufactured, and they usually last in the synthetic material for most of the lifetime of the product. The anti-microbial agents are typically odorless, tasteless and colorless, and therefore do not alter the physical characteristics of the synthetic panel or mailing device in any significant manner. Accordingly, in such embodiment, the synthetic panel or mailing device may be more desirable for public use as it is less likely to carry or deliver disease-causing microbes or biological agents to the recipient because the growth, development or accumulation thereof on the device is reduced considerably.

In another embodiment, an anti-microbial agent is added to the ink used for printing the aforementioned alphanumeric and graphic information on the synthetic panel or mailing device. Such anti-microbial agents are also commercially available from the two companies mentioned above, and perform a substantially identical function as discussed above for the anti-microbial agents added to the synthetic material. In such embodiment, accordingly, the synthetic panel or mailing device may also be more desirable for public use as it is less likely to carry or deliver disease-causing biological agents to the recipient because the growth, development or accumulation thereof on the device is reduced considerably.

In an alternate embodiment, an anti-microbial agent is added to the material of the synthetic panel or mailing device, and an anti-microbial agent is also added to the ink used for imprinting thereon. It will be appreciated that such embodiment offers dual protection against biological agents on the device, and should accordingly be more desirable. However, it is recognized that such embodiment may carry a comparatively higher manufacturing cost because of the added cost of adding anti-microbial agents to both the synthetic material and the ink.

In another embodiment, a coating is applied upon at least one surface of the synthetic panel or mailing device, and the coating includes an anti-microbial agent. Preferably, however, substantially all surfaces of the synthetic panel or mailing device includes the aforementioned coating applied thereon. The relatively narrow edges of the synthetic panel or mailing device, for example, may not have the coating applied thereon, but the comparatively broader front surface and back surface thereof will therefore comprise the aforementioned substantially all surfaces of the synthetic panel or mailing device that have the coating. Such anti-microbial agents are also commercially available from the two companies mentioned above, and perform a substantially identical function as discussed above for the anti-microbial agents added to the synthetic material. In such embodiment, the synthetic panel or mailing device may likewise be more desirable for public use as it is less likely to carry or deliver disease-causing biological agents to the recipient because the growth, development or accumulation thereof on the device is reduced considerably.

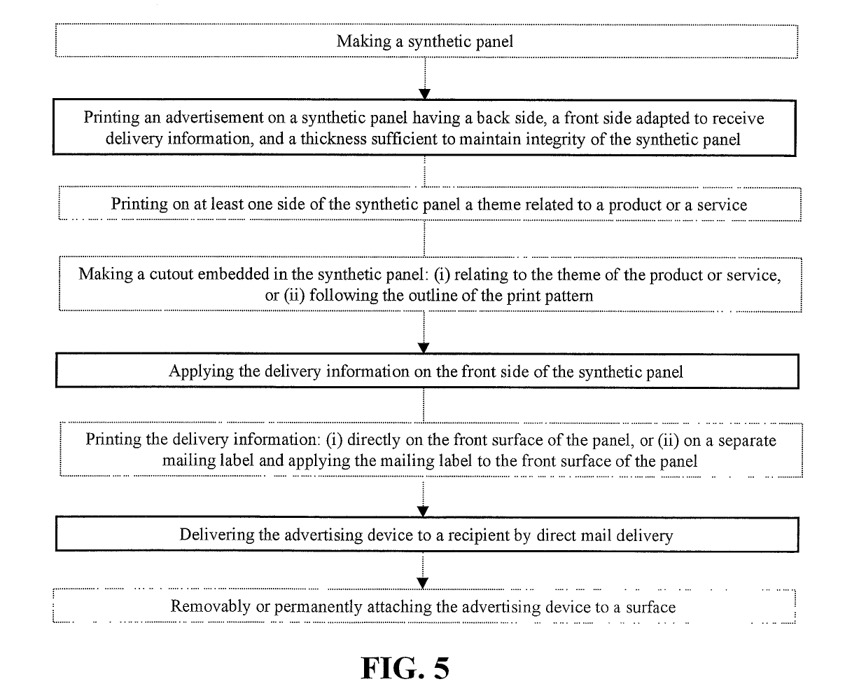

A method of delivering an advertisement device by direct mail delivery to a recipient is also provided. Referring to FIG. 5, one example of a method of delivering an advertisement device by direct mail delivery to a recipient is shown. The method of FIG. 5 may include printing an advertisement on a synthetic panel having a back side, a front side, at least one of the back side and the front side adapted to receive delivery information, and a thickness sufficient to maintain integrity of the synthetic panel; applying the delivery information to at least one of the front side and the back side of the synthetic panel; and delivering the advertising device to a recipient by the direct mail delivery. The delivery information may be printed directly on the surface of the synthetic panel, or the delivery information may be printed on a separate mailing label and then applied to the surface of the synthetic panel. The advertisement device may also have printing on at least one side of the synthetic panel a theme related to a product and/or a service. A cutout may also be embedded in the synthetic panel and may have a shape relating to a theme of a product and/or a service. The cutout may also follow the outline of the print pattern. The method may also include making a synthetic panel. The method may also include removably or permanently attaching the advertisement device to a surface for display. The method may also include adding an anti-microbial agent to the material of the synthetic panel. The method may also include adding an anti-microbial agent to the ink used for imprinting upon the synthetic panel. The method may also include applying a coating comprising an anti-microbial agent on at least one surface of the synthetic panel, or preferably upon substantially all surfaces of the synthetic panel.

The term “direct mail delivery” refers to the delivering of an advertisement device to a recipient using a courier or delivery service that transports and delivers documents, packages, cargo, parcels, and/or freight by land, sea and/or air. Such delivery services that can be used in the present invention, including but not limited to, mail delivery services such as the United States Postal Service, Federal Express Inc. (FedEx®), United Parcel Service, Inc. (UPS®), Airborne Express, Inc., and RPS, Inc., to name a few.

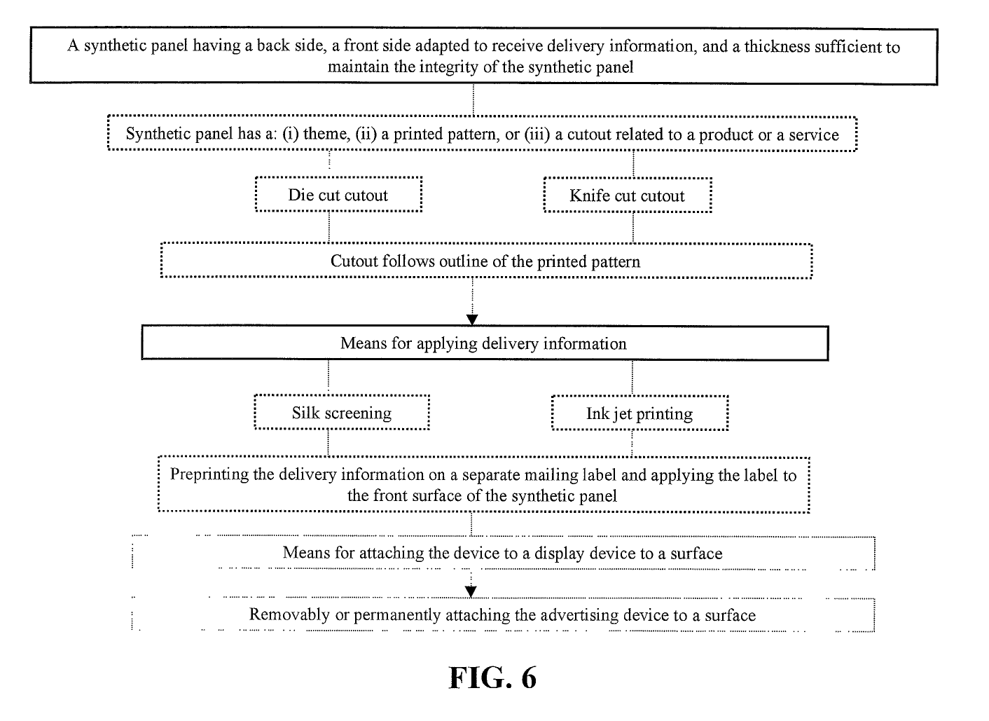

An advertising device system for direct mail delivery to a recipient is also provided. Referring to FIG. 6, one example of an advertising device system is shown. The advertisement device system of FIG. 6 may include a synthetic panel, having a back side, a front side, at least one of the back side and the front side adapted to receive delivery information, and a thickness sufficient to maintain integrity of the synthetic panel; and means for applying delivery information. The means for applying the delivery information may include silk screening, sheet fed printing, web offset printing, web letter press printing, gravure printing, and/or ink jet printing. Also, the means for applying the delivery information may include preprinting the delivery information on a separate mailing labeled and applying the label to the surface of the synthetic panel. The advertising device system may also include a synthetic panel with a theme related to a product and/or a service. The advertising device system may also have a synthetic panel with a printed pattern related to the theme of a product and/or a service; and a cutout embedded in the synthetic panel related to a theme of the product and/or a service. The cutout may be die cut or knife cut, for example. Or, the panel may even be molded in a predetermined shape by any one of the various ways known in the art. The cutout or molded panel may also follow the outline of the print pattern. The advertising device system may also include a means to removably or permanently attach the device to a surface with an adhesive, double sided tape, a loop fastener, a pile fastener, a magnet, magnetized sheeting, magnetic tape, a screw, a snap, and/or fastening tape.

The synthetic panel may also be provided with an overlaid pattern, graph, or charted surface, for example by silk-screening, to facilitate the presentation of information, or have a printed chalk compatible surface for use with chalk. Similarly, the synthetic sheet may be selected for use with dry-erase markers to provide further utility to the advertisement device.

In another embodiment of the present invention, the advertisement device is adapted for mounting on a display surface or medium, such as a wall, window or a door, etc. Such mounting is accomplished with means for fastening the advertisement device to a display surface. Such means include, but are not limited to, adhesive, heat lamination, double sided tape, loop fasteners, magnets, magnetized sheeting, magnetic tape, screws, snaps, fastening tape, buttons and button holes, stitches, suction cups, hook and eyes, zipper, static cling material, lock and key, and pile fasteners.

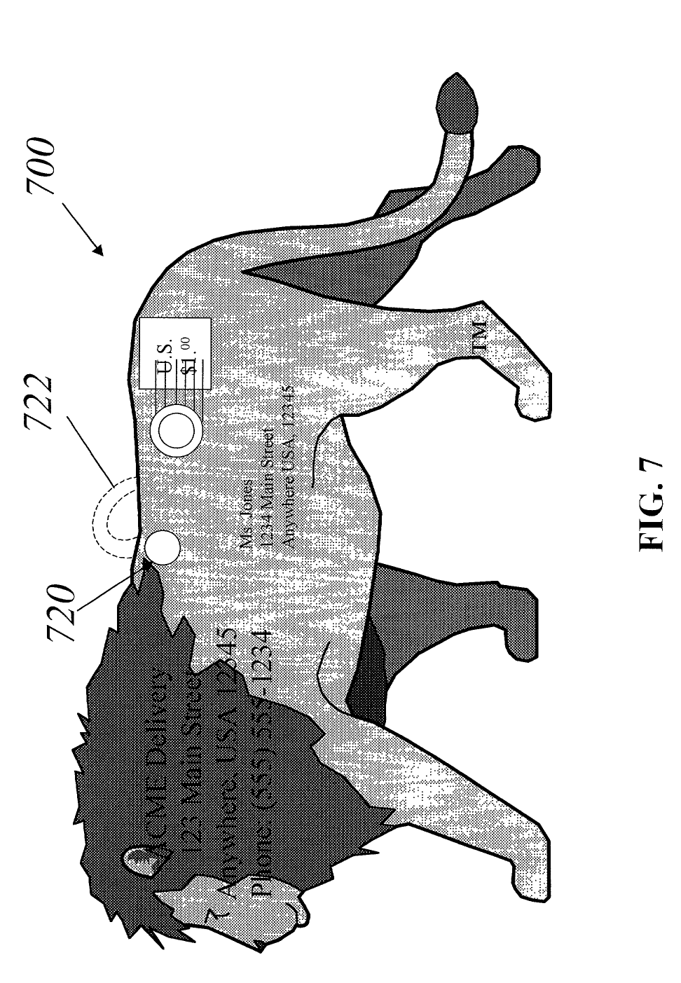

Referring to FIG. 7, a front view of an alternate embodiment of the advertisement device with a mechanism to hold the advertisement device with respect to a surface is shown. The advertisement device (700) essentially includes a mechanism, or means, for holding the device (700) with respect to a surface, such as a substantially vertical surface like a wall, to display the advertisement device (700). This feature adds to the permanence effect of the advertisement device (700) for the recipient. The mechanism for holding the device (700) with respect to a surface may be one of any number of types, such as a hole (720) in the device (700). It will be appreciated that the device (700) can be held with respect to a surface, such as a vertical surface like a wall, by inserting a nail or a hook through the hole (720). Further in this embodiment, the hole (720) may include a grommet (not shown), such as a metal or rubber grommet, lining the periphery of the hole (720) to protect the edges of the hole (720) from getting damaged during use. In another embodiment, device (700) includes a hanging extension (722) for holding the device (700) with respect to a surface. The hanging extension (722) is shown in phantom in FIG. 7, and includes an opening that may be cooperatively engaged with a nail, a hook, or the like. The hanging extension (722) may be a part of the device (700) formed along with the device (700) when it is manufactured, thereby being integral with the device (700). In another embodiment, the hanging extension (722) may be an additional component substantially rigidly attached to the device (700), such as a string, a relatively thick thread-like material, or the like. Accordingly, those skilled in the art will appreciate that a number of different means may be implemented in the device (700) to serve the purpose of holding it with respect to a surface, such as displaying the device from a vertical surface, without departing from the spirit and scope of the present invention, and therefore all such embodiments are recognized and anticipated and it is intended that the claims hereof will cover all such embodiments.

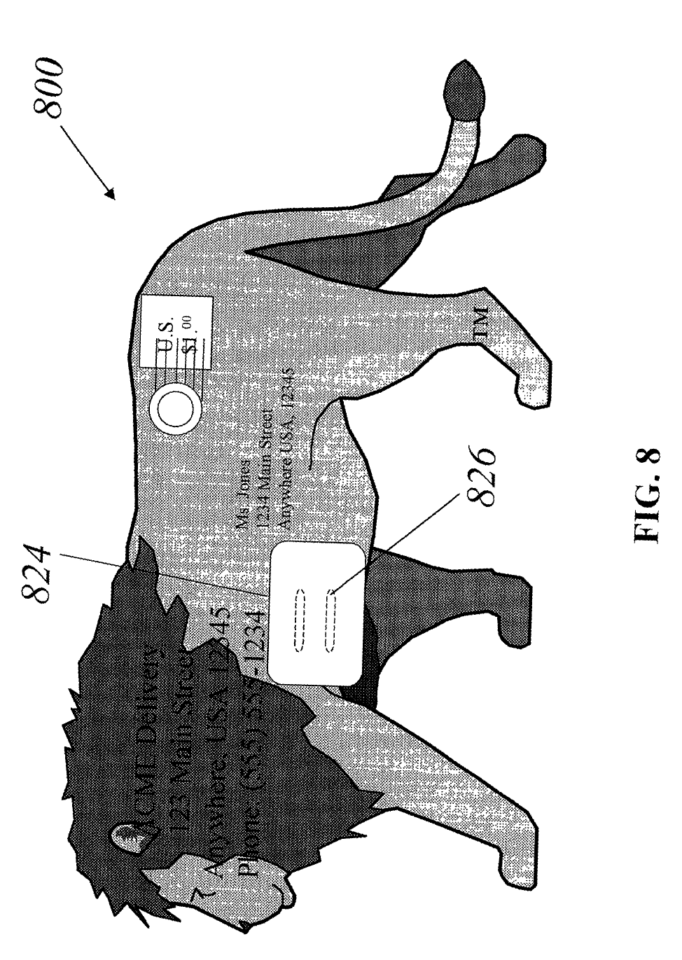

Referring to FIG. 8, a front view of an alternate embodiment of the advertisement device with a mechanism to carry another item therewith to a recipient is shown. Sometimes, it might be desirable to send an extraneous item (824), such as a business card, a credit card, or a relatively flat magnetic item that displays some relevant images and/or alphanumeric information, etc., to the recipient along with the device (800). Typically, such extraneous item (824) will be relatively flat and thin, such as a coupon, a credit card, a refrigerator-magnet, etc. although it is recognized and anticipated that it may also have a different shape and/or dimensions. The extraneous item (824) may be removably or permanently affixed to the device (800). In one embodiment wherein the extraneous item (824) is removably affixed to the device (800), the extraneous item (824) may be removably adhered to the device (800) by one or more strips of an adhesive (826) (shown in phantom in FIG. 8) whereby the extraneous item (824) can be selectively peeled off from the device (800) by the recipient or another user. The implementation and composition of such strips of adhesive is known in the art. Alternatively, the extraneous item (824) may be shrink-wrapped or overlaminated with the device (800), whereby it can be selectively unwrapped and/or detached from the device (800) by a user. The overlamination, for example, could be with a material, such as a plastic overlaminating film, that serves to hold the extraneous item (824) with respect to the device (800). In another embodiment, the extraneous item (824) is substantially permanently attached to the device (800). In such embodiment, for example, the extraneous item (824) may include a magnetic surface, whereby the device (800) may be magnetically attached to a magnet-attractable surface, such as a refrigerator door.

As used herein, the term “embedded” refers to a process of molding or carving a graphic or alphanumeric design in a synthetic panel of the advertisement device using techniques known by those skilled in the art, such as by using a die, a knife or a laser cutting tool to cut or score a graphic or alphanumeric design in a synthetic panel. The molding or carving can be on one or both sides of the synthetic panel, and of sufficient depth to allow a recipient to remove the frangible edge that results from the embedding process, and of a depth to maintain the integrity of the cutout during direct mail delivery to a recipient.

As used herein, the term “transparent” when used in reference to a transparent synthetic panel, refers to a synthetic panel that is capable of transmitting light so that objects or images can be seen through the synthetic panel as if there was little or no intervening material. The term transparent synthetic panel as used herein includes a sheet of transparent material, a laminate of transparent materials or an assembly of transparent materials, such as plastic, for example, acrylic sheets or polycarbonate sheets and including other synthetic materials such a polyester film or polyvinyl chloride film and also includes a transparent synthetic panel having an obscure or other distorted image effect.

As used herein, the term “opaque” when used in reference to an opaque synthetic panel, refers to a synthetic panel that is incapable of transmitting significant amounts of light. Opaque material is light absorbing and/or impenetrable to light and is neither transparent nor translucent.

As used herein, the term “translucent” when used in reference to a translucent synthetic panel, refers to a synthetic panel that is capable of transmitting light, but causes sufficient diffusion to prevent perception of distinct images seen through the synthetic panel. The term translucent synthetic panel is intended to include a sheet of translucent material, a laminate of translucent materials such as glass or plastics, for example, acrylic sheets or polycarbonate sheets and includes flexible materials such as polyester film, polyvinyl chloride film, paper, fabric or other material.

As used herein, the term “adhesive” refers to a material that provides or promotes adhesion. Adhesive material that can be used in the present invention include, but is not limited to, glue; paste; cement; and pressure-sensitive adhesive including tackified rubber adhesive, such as natural rubber, olefin, silicone, polyisoprene, polybutadiene, polyurethane, styrene-isoprene-styrene and styrene-butadiene-styrene block copolymers, and other elastomers; and tackified or untackified acrylic adhesives such as copolymers of isooctylacrylate and acrylic acid, which can be polymerized by radiation, solution, suspension, or emulsion techniques; and polymeric binders such as ethylene-vinyl-acetate, ethylene-methyl-acrylate, ethylene-ethyl-acrylate, ethylene-butyl-acrylate, and ethylene-methacrylicacid. The adhesive may be a crosslinked adhesive that gives high shear strength. This cross-linkage may be caused by radiation with or without a chemical cross-linking agent.

Furthermore, in some approaches to this method, in order to improve adhesion of the adhesive layer to a synthetic panel, the synthetic panel can be pretreated prior to applying the adhesive in one or more of the following ways: corona discharge, plasma discharge, flame treatment, electron beam irradiation, ultraviolet radiation, acid etching, or chemical priming. Such pretreatments can be carried out with or without reactive chemical adhesion promoters such as hydroxyethyl acrylate or hydroxyethyl methacrylate, or other reactive species of low molecular weight.

As used herein, the term “pile fastener” refers to fastening tape generally comprising a strip of nylon with a surface of minute hooks that fasten to a corresponding strip with a surface of uncut pile. Velcro™ is the most commonly used pile fastener, and includes for example, Velcro™ matting and Velcro™ loops, and Velcro™ Comp and Velcro™ loops.

Although the invention has been described with respect to specific embodiments and examples, it should be appreciated that other embodiments utilizing the concept of the present invention are possible without departing from the scope of the invention. The present invention is defined by the claimed elements, and any and all modifications, variations, or equivalents that fall within the spirit and scope of the underlying principles.

What is claimed is:

1. An advertisement device for direct mail delivery to a recipient, comprising: a synthetic panel, having a back side, a front side, at least one of said back side and said front side adapted to receive delivery information, and a thickness sufficient to maintain integrity of the synthetic panel.

2. The device of claim 1, wherein the delivery information is printed directly on a surface of said front side or said back side of said synthetic panel.

3. The device of claim 1, wherein said delivery information is preprinted on a separate mailing labeled and applied to a surface of said front side or said back side of said synthetic panel.

4. The device of claim 1, wherein said synthetic panel comprises a theme related to at least one of a product and a service.

5. The device of claim 4, wherein said synthetic panel has at least one of a printed pattern related to the theme of the product or the service, and a cutout embedded in said synthetic panel related to the theme of the product or the service.

6. The device of claim 5, wherein said cutout is die cut.

7. The device of claim 5, wherein said cutout is knife cut.

8. The device of claim 5, wherein said cutout is implemented when said synthetic panel is molded.

9. The device of claim 5, wherein said cutout follows an outline of the print pattern.

10. The device of claim 5, wherein the printed pattern comprises at least one of a name, a word, a symbol, a phrase, a term, a logo, a design, a picture, an emblem, and a scene.

11. The device of claim 10, wherein the printed image is multicolored.

12. The device of claim 10, wherein the design comprises at least one of an advertisement, a trade name, a trademark, and a service mark.

13. The device of claim 10, wherein the printed pattern is substantially the same on the front and back of said synthetic panel.

14. The device of claim 10, wherein an ink is used to print said printed pattern, and said ink comprises an anti-microbial agent.

15. The device of claim 1, wherein said synthetic panel comprises a coating on at least one surface thereof, and said coating includes an anti-microbial agent.

16. The device of claim 15, wherein said synthetic panel comprises said coating on substantially all surfaces thereof.

17. The device of claim 1, wherein said synthetic panel comprises a synthetic material which includes an anti-microbial agent.

18. The device of claim 1, wherein said synthetic panel comprises a synthetic material of at least one of vinyl, styrene, polyester, polyvinyl chloride, plastic, fabric, nylon, Nomex™, Kevlar™, polyethylene terephthalate, polycarbonate, acrylic, Plexiglas™, polypropylene, polyethylene, polystyrene, acrylonitrile-butadiene-styrene terpolymer, polyphenyleneoxidepolystyrene, polyurathane, and polyamides, and blends and combinations thereof.

19. The device of claim 18, wherein said synthetic material further comprises an antimicrobial agent.

20. The device of claim 18, wherein said synthetic panel further comprises paper, and the paper is coated, layered, covered or embedded with the synthetic material.

21. The device of claim 20, wherein said synthetic material further comprises an antimicrobial agent.

22. The device of claim 1, further comprising a means to attach the device to a surface.

23. The device of claim 22, wherein the attachment means comprises at least one of an adhesive, double sided tape, a loop fastener, a pile fastener, a magnet, magnetized sheeting, magnetic tape, a screw, a snap, and fastening tape.

24. The device of claim 22, wherein the device is at least one of removably attached and permanently attached.

25. The device of claim 1, wherein the device includes a mechanism for holding the device with respect to a surface.

26. The device of claim 25, wherein said mechanism for holding the device with respect to a surface is a hole in the device.

27. The device of claim 26, wherein said hole includes a grommet.

28. The device of claim 25, wherein said mechanism for holding the device with respect to a surface is a hanging extension.

29. The device of claim 1, wherein the device includes a mechanism to carry another item.

30. The device of claim 29, wherein said mechanism to carry another item comprises adhesive to adhere said another item to the device.

31. The device of claim 29, wherein said mechanism to carry another item comprises shrink wrap or an overlaminating material to hold said another item to the device.

32. The device of claim 29, wherein said another item is a coupon, a business card, a credit card or a refrigerator magnet.

33. A method of delivering an advertisement device by direct mail delivery to a recipient, comprising:
(i) printing an advertisement on a synthetic panel of said advertisement device, said advertisement device having a back side, a front side, at least one of said back side or said front side adapted to receive delivery information, and a thickness sufficient to maintain integrity of the synthetic panel;
(ii) applying the delivery information to at least one of said front side or said back side of said synthetic panel, and
(iii) delivering said advertising device to a recipient by direct mail delivery.

34. The method of claim 33, further comprising printing the delivery information directly on a surface of at least one of said front side and said back side of said synthetic panel.

35. The method of claim 33, further comprising printing the delivery information on a separate mailing label and applying the mailing label to the surface of at least one of said front side or said back side of said synthetic panel.

36. The method of claim 33, further comprising printing on at least one side of said synthetic panel a theme related to at least one of a product and a service.

37. The method of claim 36, wherein an ink used for printing said theme includes an anti-microbial agent.

38. The method of claim 3 6, further comprising making a cutout embedded in the synthetic panel.

39. The method of claim 3 8, further comprising making a cutout relating to at least one of a theme of a product and a service.

40. The method of claim 38, further comprising a cutout following an outline of the print pattern.

41. The method of claim 33, further comprising making a synthetic panel.

42. The method of claim 41 wherein said synthetic panel comprises a synthetic material, and further comprising adding an anti-microbial agent to said synthetic material.

43. The method of claim 41, further comprising applying a coating to at least one surface of said synthetic panel, said coating comprising an anti-microbial agent.

44. The method of claim 43, further comprising applying said coating to substantially all surfaces of said synthetic panel.

45. The method of claim 33, further comprising attaching the device to a surface.

46. The method of claim 45, wherein attaching the device to a surface comprises at least one of removably attaching and permanently attaching.

47. The method of claim 33, further comprising implementing a mechanism associated with said advertising device for holding said advertising device with respect to a surface.

48. The method of claim 37a, wherein said mechanism for holding said advertising device with respect to a surface is a hole in said advertising device.

49. The method of claim 48, wherein said hole includes a grommet.

50. The method of claim 47, wherein said mechanism for holding said advertising device with respect to a surface is a hanging extension.

51. The method of claim 33, further comprising implementing a mechanism on said advertising device to carry another item.

52. The method of claim 51, wherein said mechanism to carry another item comprises adhesive to adhere said another item to said advertising device.

53. The method of claim 51, wherein said mechanism to carry another item comprises shrink wrap or overlaminating material to hold said another item to said advertising device.

54. The method of claim 51, wherein said another item is a coupon, a business card, a credit card, or a refrigerator magnet.

55. An advertisement device system for direct mail delivery to a recipient, comprising:
(i) a synthetic panel, having a back side, a front side, at least one of said back side and said front side adapted to receive delivery information, and a thickness sufficient to maintain integrity of the synthetic panel; and
(ii) means for applying delivery information on said front side of said synthetic panel.

56. The system of claim 55, wherein said means for applying the delivery information comprises at least one of silk screening, sheet fed printing, web offset printing, web letter press printing, gravure printing, and ink jet printing.

57. The system of claim 55, wherein said means for applying the delivery information comprises preprinting the delivery information on a separate mailing label and applying the label to said front side or said back side of said synthetic panel.

58. The system of claim 55, wherein said synthetic panel comprises a theme related to at least one of a product and a service.

59. The system of claim 58, wherein said synthetic panel has at least one of a printed pattern related to the theme of the product or the service, and a cutout embedded in the synthetic panel related to the theme of the product or the service.

60. The system of claim 59, wherein an ink used for said printed pattern includes an anti-microbial agent.

61. The system of claim 59, wherein said cutout is die cut.

62. The system of claim 59, wherein said cutout is knife cut.

63. The system of claim 62, wherein said cutout is implemented when said synthetic panel is molded.

64. The system of claim 59, wherein said cutout follows the outline of the print pattern.

65. The system of claim 55, further comprising a means to attach the device to a surface

66. The system of claim 65, wherein the attachment means comprises at least one of an adhesive, double sided tape, a loop fastener, a pile fastener, a magnet, magnetized sheeting, magnetic tape, a screw, a snap, and fastening tape.

67. The system of claim 66, wherein the device is at least one of removably attached and permanently attached.

68. The system of claim 55, wherein a synthetic material used for making said synthetic panel includes an anti-microbial agent.

69. The system of claim 55, wherein said synthetic panel further comprises a coating on at least one surface thereof, and said coating includes an anti-microbial agent.

70. The system of claim 69, wherein said synthetic panel comprises said coating on substantially all surfaces thereof.

71. The device of claim 55, wherein said synthetic panel includes a mechanism for holding it with respect to a surface.

72. The device of claim 71, wherein said mechanism for holding said synthetic panel with respect to a surface is a hole in said synthetic panel.

73. The device of claim 72, wherein said hole includes a grommet.

74. The device of claim 71, wherein said mechanism for holding said synthetic panel with respect to a surface is a hanging extension.

75. The device of claim 55, wherein said synthetic panel includes a mechanism to carry another item.

76. The device of claim 75, wherein said mechanism to carry another item comprises adhesive to adhere said another item to said synthetic panel.

77. The device of claim 75, wherein said mechanism to carry another item comprises shrink wrap or overlaminating material to hold said another item to said synthetic panel.

78. The device of claim 75, wherein said another item is a coupon, a business card, a credit card, or a refrigerator magnet.
